(19) United States
(12) Patent Application Publication
(10) Pub. No.: US 2004/0204948 A1
(43) Pub. Date: Oct. 14, 2004

(54) Internet service for the travel medical professional staffing industry

(76) Inventors: Carol Singletary, Battle Ground, WA (US); John D. Singletary, Battle Ground, WA (US)

Correspondence Address: LITMAN LAW OFFICES, LTD., P.O. BOX 15035 CRYSTAL CITY STATION, ARLINGTON, VA, 22215, US

(21) Appl. No.: 10/409,314

(22) Filed: Apr. 9, 2003

(51) Int. Cl. G06F 17/60

(52) U.S. Cl. 705/1

(57) ABSTRACT

A fee based internet-based job brokerage service for travel medical professionals. The system enables a registered medical facility to post, edit or update job openings on an internet web site which can then be queried by registered staffing agencies. The staffing agency then enters the professional profile of a perspective candidate into a secure web hosted database and then applied against the posted job opening. Medical facilities may then review all candidate data and initiate online negotiations with the staffing agency. Upon contract agreement, the system invoices the staffing agency for a referral fee and serves as the conduit for hours invoiced and payments made against those invoices. Advantageously, staffing agencies will serve as a buffer between the medical facilities and the individual job candidates, by screening candidates for a particular job and distilling candidate data by entering only requested candidate information in the fields provided on the website.

### BACKGROUND OF THE INVENTION

1. Field of the Invention

The present invention relates generally to third-party job placement and managing services. More particularly, the present invention relates to internet-based temporary employment management services for healthcare providers and medical temporary staffing agencies (MTSCs).

2. Description of the Related Art

Industry analysts' project that healthcare organizations will face a shortage of qualified nursing and skilled medical professionals for the foreseeable future. Currently, there are over 126,000 nursing positions that the American Hospital Association projects hospitals will be unable to fill by direct-hiring staff members. This inability to fill necessary openings has led to the situation where, in many states, as many as 53% of licensed nursing professionals are not working directly for medical care facilities. Rather, these professionals work indirectly through travel nurse agencies because they enjoy higher wages and greater personal flexibility, while maintaining steady employment and full benefits.

The growing demand for qualified healthcare professionals in the fragmented travel nurse industry has created an environment in which healthcare facilities must rely on these travel nurse agencies to staff vacant positions. Travel nurse agencies, in turn, strive to staff these positions from their own limited pool of professionals seeking specific jobs across the country.

Unlike many other industries, there are currently no centralized resources for posting positions for travel healthcare professionals. For healthcare facilities, this lack of infrastructure has created a system where human resource staff members are required to work with several travel nursing companies at a time to recruit for medical professionals, and are therefore faced with invoices from multiple agencies. Human resource managers at medical facilities are typically frustrated at having openings that their currently contracted agencies cannot fill, while at the same time having to turn away calls from uncontracted agencies having trained professionals readily available. Consequently, MTSCs have developed a reputation in the industry for driving-up the hourly staffing rates because there is no system in place, which would allow medical facilities to easily post a position viewable by a multitude of bidding staffing companies. These challenges in the travel healthcare industry have created the need for a standardized, accessible listing service.

Business methods for matching employer requirements to perspective employee desires are not unknown. U.S. Patent Publication No. 2002/0046074, published in 2002, describes a method and computer program for employee recruitment that may be used to identify, assess and place employment candidates. The program allows a client employer to manage a candidate search by guiding the client through a series of steps that include defining and describing the job, searching for candidates, screening and hiring candidates. The program also provides a method for managing a job search including resume building, researching a job, networking, searching for a job, and interviewing. Clients and job candidates are able to access various databases including candidate and client databases.

U.S. Patent Publication No. 2002/0072946, published in June, 2002, describes a method of providing a job placement service in the form of a website. The website consists of various databases including employment listings, employer information, and resumes that can be accessed and manipulated using a graphical user interface.

U.S. Patent Publication No. 2002/0133369, published on Sep. 19, 2002, discloses a system and method for agency based posting and searching of job openings via a computer system and network.

U.S. Pat. Nos. 5,978,768 and 6,370,510, issued in 1999 and 2002, respectively, to McGovern et al., disclose a method and system for providing an Internet based employment-recruiting service. The service allows a plurality of companies to advertise job positions in one location, which can be accessed by job seekers via the Internet.

U.S. Pat. No. 6,466,914, issued to Mitsuoka et al. in 2002, describes a job brokering system for offering jobs over a network and minimizes complicated negotiations between job provider and contractor. A broker program on a server receives job offers from anonymous job-provider clients and receives job applications from anonymous contractor clients. The broker program then matches a contractor to a particular job and notifies the parties of this fact.

The general features and utilities of the aforementioned references are insufficient to adequately support the temporary healthcare staffing industry. For the most part, being designed for generic job placement, they fail to address the specific requirements of the healthcare industry. In addition, none of the inventions referenced go beyond job placement and addresses the problems facing a healthcare provider in managing a host of medical professionals working for different MTSCs.

None of the above inventions and patents, taken either singly or in combination, is seen to describe the instant invention as claimed. Thus an Internet service for travel medical professional staffing industry solving the aforementioned problems is desired.

### SUMMARY OF THE INVENTION

The Internet service for the travel medical professional staffing industry or Temporary Medical Staffing System, hereafter referred to as the TMSS, provides support for the temporary medical staffing industry by providing centralized, Internet-based utilities that facilitate job brokerage, time reporting, invoicing and payment services. Specifically designed for healthcare providers and medical temporary staffing companies (MTSCs), the TMSS facilitates the acquisition of temporary medical professionals, the recordation of hours worked by the medical professional, invoicing the healthcare provider for hours worked, and the payment to the MTSC for services rendered by their contracted medical professionals.

Designed for use by a plurality of healthcare providers, MTSCs and traveling medical professionals, the TMSS comprises a combination of web servers and database/application servers connected to a telecommunication network. Residing on the servers is a database and application software which provides the user interface, stored information and utilities specific to the temporary healthcare industry. Users access the TMSS via their own Internet-connected computer equipped with a standard web browser.

To utilize the TMSS, a healthcare provider posts its temporary medical professional staffing requirements to a secure website, where MTSCs login and review the requirements and respond by presenting the professional qualifications of their respective medical professionals. The healthcare provider reviews the offers, selects a medical professional, and initiates a dialog with the MTSC if necessary, culminating in a contract signed by both parties. An invoice based upon a referral fee is generated by the TMSS and the MTSC's account is adjusted accordingly.

The medical professional performs his or her contracted duties at the provider's location and enters the hours worked into the TMSS, which upon approval by the provider, prepares a single invoice to the healthcare provider for all their temporary healthcare contracts, broken down by MTSC and contract. An invoice is also generated for the MTSCs indicating the healthcare provider and contract. Payments by the healthcare provider for received services are made through the TMSS which distributes funds to the staffing agencies according to the agreed to contracts.

The TMSS website will thus serve as a centralized interactive data store for travel medical positions which will greatly expand medical facilities' access to qualified healthcare workers. At present, healthcare providers are limited to working with a small number of MTSCs, resulting in a limited number of medical professionals from which to choose, thereby limiting the ability of hospitals and medical facilities from accessing the most competent medical professionals at competitive wages. The TMSS addresses this problem by inviting MTSCs from all geographic locations to offer their candidates for a given job opening, thereby creating a more competitive market by expanding the supply of qualified candidates to meet the demand for such workers. By interfacing with a single source, healthcare providers can efficiently access the professional profiles of a multitude of MTSCs to fulfill their temporary staffing needs. MTSCs will also benefit by gaining access to a far greater number of job listings than would otherwise be available due to geographical and contractual constraints. Furthermore, the TMSS helps healthcare providers to maintain multiple contracts with different MTSCs by providing time recording and billing features which simplify the contract management processes for both the healthcare providers and MTSCs.

Accordingly, a principal object of the invention is to provide the travel healthcare industry with a web based, centralized, job brokering and maintenance system that can be accessed by healthcare providers and MTSCs, from which temporary professional staffing contracts can be negotiated online and weekly invoices can be generated and payments made.

It is another object of the invention to provide a searchable list of current job openings in the travel healthcare industry matching candidate qualifications and work experience with job requirements for the position in question.

It is a further object of the invention to provide a means for healthcare providers to gain access to a larger pool of qualified candidates in the travel medical profession, thereby creating a more competitive labor market.

Still another object of the invention is to provide a means for MTSCs in the travel healthcare field to gain access to more job listings than would otherwise be available in their local markets.

Another feature of the website will enable a healthcare provider to store a list of former contracted personnel who were referred through the website. Healthcare providers can review this list and identify any returning medical professional who is seeking repeat employment with the facility. The list will also provide performance evaluation information, allowing the healthcare provider to make an informed decision as to whether to re-employ the medical professional.

Another object of the system is to manage the weekly invoicing of contract hours performed throughout the duration of the contract, and present both the healthcare provider and staffing agency with a simplified report of their respective contracts.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an block diagram of an Internet service for travel medical professional staffing industry according to the present invention.

FIG. 2A is a flow chart representing website options for healthcare providers according to the Internet service of FIG. 1.

FIG. 2B is a flow chart representing website options for medical temporary staffing agencies according to the Internet service of FIG. 1.

FIG. 2C is a flow chart representing website options for medical professionals according to the Internet service of FIG. 1.

FIG. 3 is a block diagram representing the relationship between the data elements stored within the database according to the Internet service of FIG. 1.

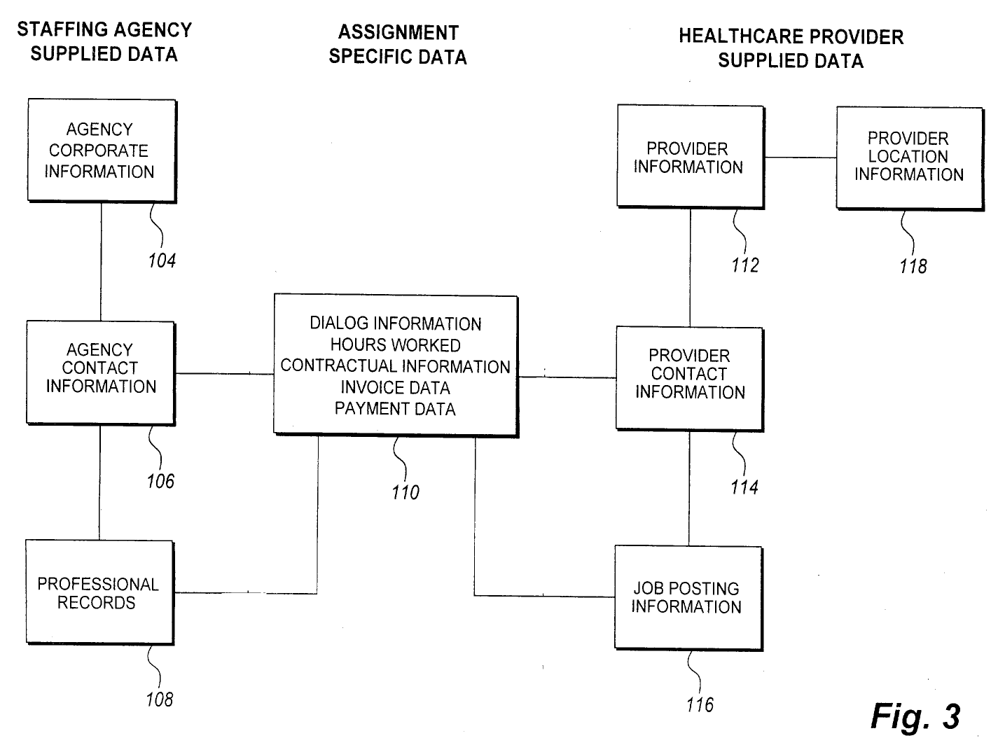

Similar reference characters denote corresponding features consistently throughout the attached drawings.

### DETAILED DESCRIPTION OF THE PREFERRED EMBODIMENT

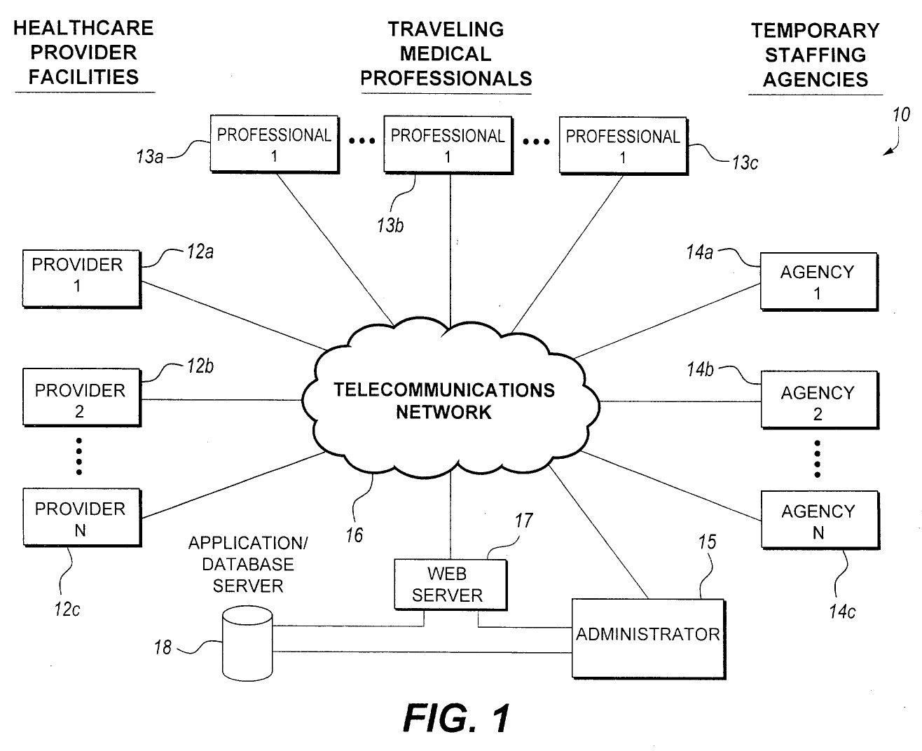

FIG. 1 provides an environmental overview of the TMSS 10 illustrating the connectivity between pluralities of healthcare providers 12, MTSCs 14, medical professionals 13, and at least one TMSS administrator 15. Each user computer, equipped with browser application software, is electrically connected to a computer network 16 having Internet access to at least one web server 17 running FrontPage Server, the web server acting as the public front-end to an SQL Database running on at least one application or database server 18. The servers contain the database and program instruction means for implementing the features and functions of the TMSS 10. Internetworking technology, including web servers, firewalls, application servers, database servers, HTML, and CGI scripting is known to those knowledgeable in the art and the technologies envisioned in the present embodiment are subject to change as new internetworking technologies emerge and are implemented in the public domain. In addition to accessing the TMSS servers 17, 18 via the Internet 16, the TMSS administrator 15 may access the TMSS servers 17,18 directly.

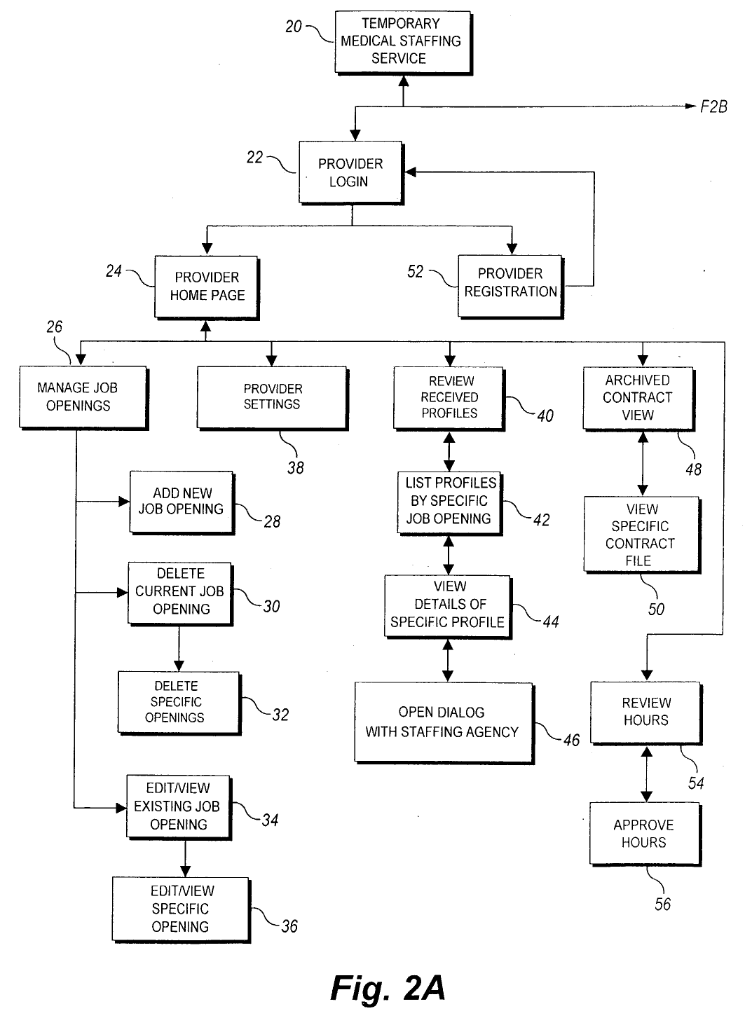

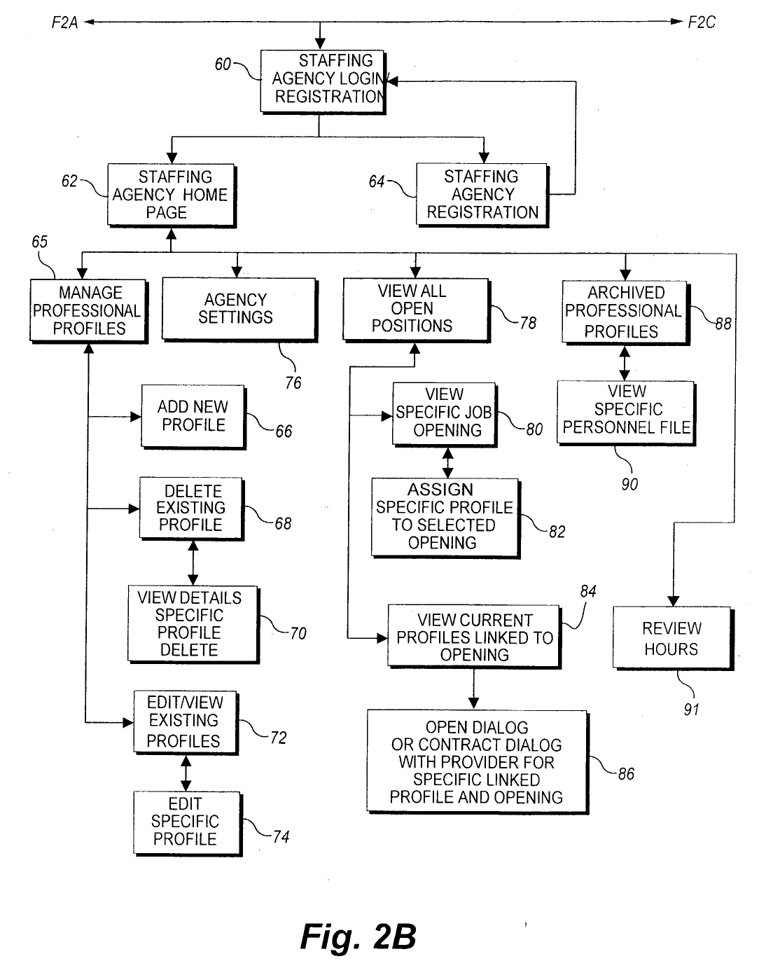

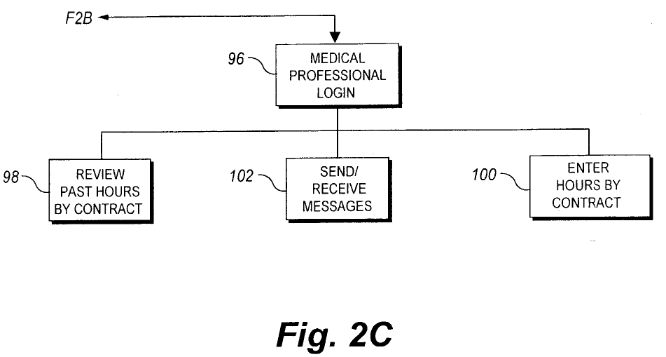

The overall functionality of the TMSS 10 is best portrayed in FIGS. 2A-2C which illustrates the general options available to a healthcare provider 12, a staffing agency 14, and a traveling medical professional 13 when they login after registering at the TMSS website located on the TMSS web server 17.

As shown in FIG. 2A, a visitor to the TMSS web site 20 is presented with the option to identify themselves as a healthcare provider, a MTSC, or a traveling medical professional. The TMSS home page 20 also provides a visitor with information regarding the TMSS 10, including contact information.

Healthcare Provider/Facility Users

Healthcare providers and facilities are, for the purpose of this application, recruiting companies involved in direct patient care and include, but are not limited to: hospitals, clinics, doctors offices, eye clinics, dental offices, rehabilitation centers, psychological hospitals, nursing homes, retirement centers, occupational nursing, and school nurses. FIG. 2A details the options available to a healthcare provider accessing the TMSS website at the “Provider Login/Registration” web page 22. All users of the TMSS 10 must have a user-id and password to access the application and data server. A healthcare provider with a user-id and password can login at the “Provider Login/Registration” screen 22 and proceed to the “Provider Home Page” 24. A non-registered healthcare provider can register at the “Provider Registration” screen 52.

The “Provider Home Page” 24 enables the provider to perform a variety of utilities by clicking on the appropriate menu option. These options includes: “Manage Job Openings” 26, “Review Received Profiles” 40, “Preferences/Settings/Information” 38, “Archived Contract View” 48, and “Review Hours” 54.

By selecting the “Manage Job Openings” 26 option, the user will be able to select whether they wish to list a “New Job Opening” 28, “Edit/View Current Openings” 34, or “Delete Existing Job Opening” 30.

After selecting “New Job Opening” 28, a healthcare provider enters data relative to the new temporary job opening in the provided fields. Data recorded includes but is not limited to: location, unit, medical discipline, start date, duration of opening, number of beds on unit, hours of shift, weekly schedule, length of orientation, certification required, certifications desired, on call required, and hourly rate. In addition, the assignment is rated for urgency, and if the assignment is listed as urgent it will pop to the top of the of current openings list displayed in the “Edit/View Specific Openings” screen 36. To help the healthcare provider determine the hourly rate, a pop-up window displays the average hourly rate for similar openings for the user's specific state, region, and national wages. These average rates are continually updated with new values as new contracts are negotiated.

The job opening information enables the TMSS 10 to automatically match a specific medical professional to a specific temporary opening.

By selecting “Edit/View Current Openings” 34, or “Delete Current Job Openings” 30, the user sees all current job openings entered by that user and may drill down to the specific job opening to either edit/view or delete by selecting the respective “Edit/View Specific Opening” 36 or “Delete Specific Opening” 32. The complete record is displayed whether the user is editing, viewing, or deleting the record.

By selecting the “Review Received Profiles” option 40, the healthcare provider is given the opportunity to see the list of current openings with the number of profiles received against each opening. By selecting a specific job opening, the TMSS 10 displays the “List Profiles by Specific Job Opening” screen 42 and lists all the profiles responding to that opening with a subset of information fields relative to the listed profiles. By selecting a specific profile 44, the healthcare provider can view the complete record for the selected profile. The medical profile provides a general picture of the medical professional's ability to provide competent healthcare and enables the healthcare provider to make an informed hiring decision based on skill, experience, knowledge, training, and past performance. Noted on the profile will be the medical discipline such as RN, MD, PT, the area of expertise, the states of licensure, any certifications such as ACLS (Advanced Cardiac Life Support), PALS (Pediatric Advanced Life support), years of experience, a checklist of completed skills, an indication of whether a background check has been completed and an indication of a urine drug screen. Also listed is the individual's mean performance score, along with access to any notes about their performance from previous temporary assignments.

After review the displayed data, the healthcare provider may select one of three options: request more information, set up an interview, either telephonic or electronic, reject the profile, or sign a contract. The TMSS 10 manages the communications, both electronic and telephonic, between the healthcare provider and the MTSC, thereby serving as the switchboard for all communications between the parties.

A preferences submenu 38 provides the healthcare provider with the ability to set their own system preferences and includes the capability to change the screen and character appearance, generate printouts, edit and view performance evaluations, list deleted or filled openings, set parameters for the number of profiles to receive for each opening, and enter their MTSC preference list of up to five staffing agencies.

By activating the “Archived Contract View” screen 48, the healthcare provider is presented with a list of all the temporary staff contracted within the past five years. By selecting the “View Specific Contract File” option 50, the user will be presented with a listing of all the pertinent data in the selected medical professional's personnel record, including: identification, I9 tax forms, professional certifications, such as Basic Cardiac Life Support (BCLS) and Advanced Cardiac Life Support (ACLS), skills checklist, background check, drug screen, specific performance evaluation for the selected contract.

MTSC Users

As shown in FIG. 2B, a MTSC user accessing the TMSS 10 website is directed to the “Staffing Agency Login/Registration” screen 60 where the MTSC user has the option of either entering their user-id and password information, or to set up a new account by registering using the “Staffing Agency Registration” form 64. Registration information includes information specific to a MTSC including but not limited to the name of the company and DBA, liability insurance coverage and terms, and state licensure/corporation license.

After logging in, a MTSC user is presented with the “Staffing Agency Home Page” 62 which contains a menu with the option to: manage their professional profiles 65, view open positions 78, review their system settings 76, review achieved professional records 88, or to review hours entered by their medical professionals 91.

From the “Manage Professional Profiles” 65 screen, the MTSC will have the following options: “Add New Profile” 66, “Edit/View Existing Profiles” 72, and Delete Existing Profile” 68. By selecting the “Add New Profile” option 66, a MTSC user will be able to fill in information related to the new position including but not limited to the name of the new medical professional, their title, years experience in field, current state licenses, current certifications, performance evaluation, a copy of skills checklist, whether the background check has been done, and whether a copy of the urine drug screen is on file.

By selecting the “Edit/View Existing Profiles” option 72, the MTSC user will be able to see a list of current profiles and a limited number of fields related to each profile. The data shown includes: employee number, name, date of hire, discipline, specialty, date assignment ends (if not on assignment date will not be listed), name of recruiter. The data is presented as a result of a query of the stored data based upon the above listed fields. By selecting a specific profile, the “Edit Specific Profile” screen 74 enables the MTSC to view the entire record of the selected profile and edit it if desired.

To delete a specific profile, a MTSC selects the “Delete Existing Profile” option 68 at which time the TMSS 10 displays all current profiles for that MTSC. The information displayed is limited to: employee number, name, date of hire, discipline, specialty, date assignment ends (if not on assignment date will not be listed), and the name of recruiter. As in the “Edit/View Existing Profiles” screen 72, the user may query the database based upon the listed fields. By selecting a specific profile that they wish to delete, a user is presented with a screen 70, which displays the specific information of the selected profile to be deleted if confirmed by password.

The MTSC users have the ability to access the general listing of current temporary job openings nationwide and to present the medical profiles of their medical professionals for specific positions. By selecting the “View All Open Positions” option 78, the MTSC accesses a list showing: job opening identification number, discipline, specialty, city, state, starting date. By selecting one of the openings, a screen 80 presents the specific requirements of that opening for review.

Upon selection, the MTSC is presented a pop-up screen 82 by which the user can pull up the profiles of their medical professionals, select a specific profile and automatically link it to the specific job opening they were reviewing. By linking a profile to a job opening, this link will appear in the user's list of pending offers 84. The list will show the following information regarding the profile/opening link: employee number, name, discipline, specialty, name of recruiter, and job opening identification number, and notification of provider interest. It is possible to have multiple openings linked to a specific profile as well as multiple profiles linked to one opening. The list may be queried and sorted by any of the listed fields. Additional information regarding the job opening is also provided and includes: discipline, specialty, city, state, starting date, phone interview requested y/n, and whether contractual negotiations have been initiated. By selecting a specific link, the MTSC may enter into a dialogue with the healthcare provider, set up the phone interview, and finalize a contractual agreement 86. Dialogue information will be stored with the link and will available upon demand.

A web page 76 is provided enabling the MTSC and their sub-users to select their system preferences, settings, and receive information relative to the TMSS 10. A representative listing of these parameters are provided in Table 1.

TABLE 1

| | Staffing | |
|---|---|---|
| Feature | Agency | Sub-User |
| Interface appearance (color, font, style, size) | X | X |
| Contract review | X | X |
| Contract print out, or cancellation | X | |
| List Deleted/Assigned Professional Profiles | X | X |
| Add or Delete sub users | X | |
| Password administration | X | X |
| Contact options: email, phone, and fax | X | X |
| Suggestions | X | X |
| Message board | X | X |
| List profiles | X | X |
| List healthcare providers currently registered | X | X |
| List current agency sub-users | X | X |
| List number of profiles linked to each sub-user & | X | |
| number of openings filled by sub-user. | | |
| Choose viewing parameters for database | X | X |
| Show current Accounts Payable information | X | |

In addition to specifying parameters specific to the MTSC user, the preferences menu 76 enables the MTSC to send and receive messages to/from the TMSS administrator 15, and to request an automated notification of any job openings that matches the skills and specifications of a particular medical professional.

An “Archived Professional Profiles” 88 screen allows a MTSC user to review the profile list of all medical professionals contracted by that MTSC. The listing contains: employee number, name, date of hire, discipline, specialty, the date the contract ended, name of recruiter, and location of assignment. Optionally, a MTSC user may view all open contracts or a subset of all contracts based upon a user defined query. By selecting a specific profile the MTSC will be able to view the specific information of that specific contract/profile 90. From this screen the MTSC will be able to review in detail the complete personnel file of their medical professional at the time of the assignment to a temporary medical opening. If the MTSC is reviewing a specific personnel file of a current assignment, new information may be added at this point to the current assignment, confirmed by password. Representative information available from the achieved database is listed in Table 2.

TABLE 2
Application - completed and signed (should include demographic
info)
Skills checklist - signed
3 reference sheets/performance evaluations
Consent to release information
I-9 form
W-4
Background check form
Confidentiality form
All Professional License(s) (signed copy) need both front and back
Current BCLS Certification (signed copy) need both front and back
Copy of Driver's License or picture ID
Copy of social security card
Copy of all current certifications
Signed Physicians statement & PPD
Immunization records
Hepatitis B Vaccination form
Results from Drug screen
ID Badge
Skills test
Received education in: Electrical safety, fire/life safety, chemical safety,
general safety reporting malfunction equipment, OSHA, regarding
infection
control, security, age specific information, blood borne pathogens,
hazardous
materials, and body mechanics.
Age specific competencies
EEO Form
Forms requested by specific healthcare provider/Facility

The MTSS has the capability to review the hours logged by their respective medical professionals 91. This capability is informational only and does not affect the invoicing of the healthcare provider.

Temporary Medical Professional Users

Once the temporary job opening contract is initiated, the medical professional performs against the contract and is responsible for weekly submittal of hours logged. As shown in FIG. 2C, the medical professional accesses the TMSS 10 website and logs in at the medical professional login screen 96. The medical professional is presented with three options: review their past recorded hours 98, to enter their hours for the week against the appropriate contract 100, or to send or receive messages 102 to/from the TMSS administrator 15.

TMSS Administrators

The TMSS administrator 15 has at their disposal a number of utilities unavailable to other users. Information and reporting capabilities available to the TMSS administrator 15 include but is not limited to the information listed in Table 3.

TABLE 3
Quantity of job openings (queried by status, provider, etc.)
Quantity of job openings currently posted per Provider
Breakdown of job openings (current negotiations, telephone interview,
contract signed, deleted, reason for deletion, and total number of
profiles submitted to job opening)
Quantity of profiles posted (queried by staffing agency or time period)
Breakdown of profile outcomes (current negotiations, telephone
interviews, contracts signed, deleted & reason for deletion, total number
of job openings to which submitted)
List healthcare providers and their registration date
List staffing agencies and their registration date
List number of assignment links by variable queries
Breakdown outcome of assignment links (current negotiations,
telephone interview, contract signed, canceled)
Generate reports based upon the hours invoiced and payments made

Automatic Invoicing

The TMSS 10 has the capability to record hours logged by the medical professionals, to invoice the healthcare provider on behalf of the MTSC for hours worked by their medical professionals, and to receive and route payments from the healthcare provider to the appropriate MTSC. Hours worked are entered by the medical professional and must be approved 56 by the appropriate healthcare provider prior to being accepted by the TMSS 10. Supervisors designated by an entry in the healthcare provider's preferences submenu 38 are responsible for approving hours submitted by the medical professionals. Normally, signature authority is divided into “non-overtime” authority and “overtime” authority. On a scheduled basis the hours entered by the medical professional and approved by the designated supervisor are processed by the TMSS 10, and a report is available for viewing by the healthcare provider and MTSC. A single invoice is prepared for the healthcare provider, which includes all contracts for all MTSCs for the particular healthcare provider. On the staffing agency side, the TMSS 10 generates a single report indicating the amount paid by each healthcare provider to that MTSC.

The TMSS 10 further comprises utilities that facilitate the disbursement of funds from the healthcare providers to the various MTSCs. Funds received from the healthcare provider for payment on temporary employment contracts would entail a payment against a single invoice and the TMSS 10 would channel the funds to the appropriate MTSC.

Stored Data Relationships

The data stored by the database 18 can be best described as three types of information: data supplied by the MTSC, data supplied by the healthcare provider, and data specific to the assignment created by the contract between the healthcare provider and the MTSC regarding a specific job opening. As previously described, the MTSC supplies data regarding the agency 104, agency contact information 106, and the professional profiles and the complete personal files of its medical professionals 108. The relationship of the agency-supplied data is such that a single MTSC may have multiple contacts and multiple professional records. For the healthcare provider, a single provider may have multiple locations 118, multiple contacts 114, and multiple jobs posted 116. The most actively changing data is the specific assignment data for each contract between a healthcare provider and a MTSC 110. This data includes dialog data between the healthcare provider and the MTSC, contractual information, hours worked by the medical professional, and invoice and payment data.

It is to be understood that the present invention is not limited to the embodiment described above, but encompasses any and all embodiments within the scope of the following claims.

We claim:

1. An employment contract generating and contract management system, comprising:
at least one server computer having an interface for communication over a computer network, said server further comprising application program means and a memory for storing data for access by said application program means, said memory further comprising a data structure stored in said memory, said data structure including:
recruiting company corporate data;
staffing agency corporate data;
professional profiles for all contractors employed by each staffing agency;
a preferred list of staffing agencies for each recruiting company;
job requirement data entered by said recruiting company; and
contract negotiation dialog data for each negotiated contract between said recruiting company and said staffing agency.

2. The contract generating and management system of claim 1, wherein said data structure further comprises:
contractor logged hours applied against each negotiated contract; and
invoice and payment data for each of said negotiated contract.

3. A system for generating and managing contractual agreements between recruiting companies and staffing agencies, comprising:
at least one server computer hosting a system for facilitating the matching of staffing agency candidate qualifications with recruiting company job requirements accessible via a computer network by the computers of at least one recruiting company and at least one staffing agency under control of a third job brokering company;
said at least one server providing a user interface wherein:
(a) recruiting companies upload company information, contact information, and staffing agency preferences to a secure medium;
(b) recruiting companies post their staffing requirements to a secure medium;
(c) staffing agencies upload company information and employee profiles to a secure medium;
(d) staffing agencies and recruiting companies may identify and negotiate contracts online; and
(e) staffing agencies are automatically notified of said posted staffing requirements that match said staffing agency's employee profiles.

4. The system of claim 3, wherein said at least one server further provides a user interface wherein:
(f) contractor personnel may enter and review their hours worked;
(g) recruiting companies may sign off said hours worked; and
(h) recruiting companies may review all hours worked.

5. The system of claim 3, wherein said at least one server further provides a user interface wherein:
(i) recruiting companies may review achieved contracts;
(j) recruiting companies may review average hourly rate for similar posted staffing requirements for the state, region, and national markets; and
(k) staffing agencies may review achieved employee profiles.

6. A method for generating a contractual agreement between recruiting companies and staffing agencies, tracking the hours invoiced by staffing agencies, and allocating payments made by recruiting companies, comprising the steps of:
(a) providing at least one server computer in communication with a computer network;
(b) providing human interface service means for adding, editing, and deleting job openings requests from a browser interface on a recruiting company's internet connected computer;
(c) providing human interface service means for adding, editing, and deleting professional profiles of contractor personnel from a browser interface on a staffing agency's internet connected computer; and
(d) exchanging applicant information between recruiting companies and staffing agencies.

7. The method of claim 6, further comprising the steps of:
(e) providing automated service means for automatically matching a job opening to a professional profile based upon the matching of related parameters;
(f) providing human interface service means for facilitating the negotiating of a contract between said recruiting company and said staffing agency; and
(g) providing automated service means for billing referral fees to said staffing agency.

8. The method of claim 6, further comprising the steps of:
(h) providing human interface service means for entering hours worked by said contractor personnel;
(i) providing human interface service means for approving said hours;
(j) providing automated service means for invoicing said recruiting company for hours entered by contractor personnel; and
(k) providing automated service means for allocating payments from said recruiting companies to said staffing agencies.
